(19) United States
(12) Patent Application Publication
(10) Pub. No.: US 2013/0141335 A1
(43) Pub. Date: Jun. 6, 2013

(54) MOUSE

(71) Applicant: Meng-Chuan Chen, TAIPEI CITY (TW)

(72) Inventor: Meng-Chuan Chen, TAIPEI CITY (TW)

(21) Appl. No.: 13/684,579

(22) Filed: Nov. 26, 2012

(30) Foreign Application Priority Data
Dec. 2, 2011 (CN) 201110394093.7

(51) Int. Cl. G06F 3/0354

(52) U.S. Cl. CPC G06F 3/03543
USPC 345/163

(57) ABSTRACT

A mouse includes a main body, a scroll-wheel ring, an embedded shaft, a ball, and an elastic member. The scroll-wheel ring is rotatably disposed in the main body and has a ring-shaped gear portion. The ring-shaped gear portion has a plurality of gear teeth and tooth spaces alternately formed thereon. The embedded shaft is fixed to the main body and embedded into the scroll-wheel ring. The embedded shaft has a containing space opening toward the ring-shaped gear portion. The ball is disposed in the containing space and contacts the ring-shaped gear portion. The elastic member is disposed in the containing space. Two ends of the elastic member abut against an inner wall of the containing space and the ball respectively. When the scroll-wheel ring is rotated, the gear teeth and the elastic member drive the ball to switch between different tooth spaces with rotation of the scroll-wheel ring.

### BACKGROUND OF THE INVENTION

1. Field of the Invention

The present invention relates to a mouse, and more specifically, to a mouse with an improved scroll wheel structure.

2. Description of the Prior Art

A scroll wheel of a conventional mouse utilizes a grating design in which a wheel-shaped grating structure is formed in the scroll wheel and the scroll wheel has a ring-shaped rubber cover disposed thereon. For providing a user with a rolling feeling while rotating the scroll wheel, a metal rod is disposed in the mouse for contacting the inner surface of the scroll wheel, and a tooth structure is correspondingly formed on the inner surface of the scroll wheel. In such a manner, the user could have an obvious rolling feeling by the metal rod contacting the tooth structure while rotating the scroll wheel.

However, during rotation of the scroll wheel, collide of the metal rod with the tooth structure may make a great noise, especially when metal fatigue of the metal rod occurs after the mouse is used over a period of time.

Furthermore, since the aforesaid grating design requires many components for assembly of the mouse, it also causes a higher manufacturing cost of the mouse.

### SUMMARY OF THE INVENTION

The prevent invention provides a mouse including a main body, a scroll-wheel ring, an embedded shaft, a ball, and an elastic member. The scroll-wheel ring is rotatably disposed in the main body and has a ring-shaped gear portion. The ring-shaped gear portion has a plurality of gear teeth and tooth spaces alternately formed thereon. The embedded shaft is fixed to the main body and embedded into the scroll-wheel ring. The embedded shaft has a containing space opening toward the ring-shaped gear portion. The ball is disposed in the containing space and contacts the ring-shaped gear portion. The elastic member is disposed in the containing space. One end of the elastic member abuts against an inner wall of the containing space, and the other end of the elastic member abuts against the ball. When the scroll-wheel ring is rotated, the gear teeth and the elastic member drive the ball to switch between different tooth spaces with rotation of the scroll-wheel ring.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional diagram of a mouse according to an embodiment of the present invention;

FIG. 2 is a sectional diagram of an embedded shaft in FIG. 1;

FIG. 3 is a sectional diagram of a scroll-wheel ring in FIG. 1;

FIG. 4 is a top view of the scroll-wheel ring in FIG. 3;

FIG. 5 is a diagram of a ball in FIG. 1 being located in one tooth space;

FIG. 6 is a diagram of the ball in FIG. 5 being disposed on a top end of one gear tooth;

FIG. 7 is an enlarged diagram of a fixed board in FIG. 1;

FIG. 8 is a sectional diagram of the fixed board in FIG. 7 along a sectional line A-A′; and

FIG. 9 is an assembly diagram of the scroll-wheel ring, the fixed board, and a circuit board in FIG. 1.

### DETAILED DESCRIPTION

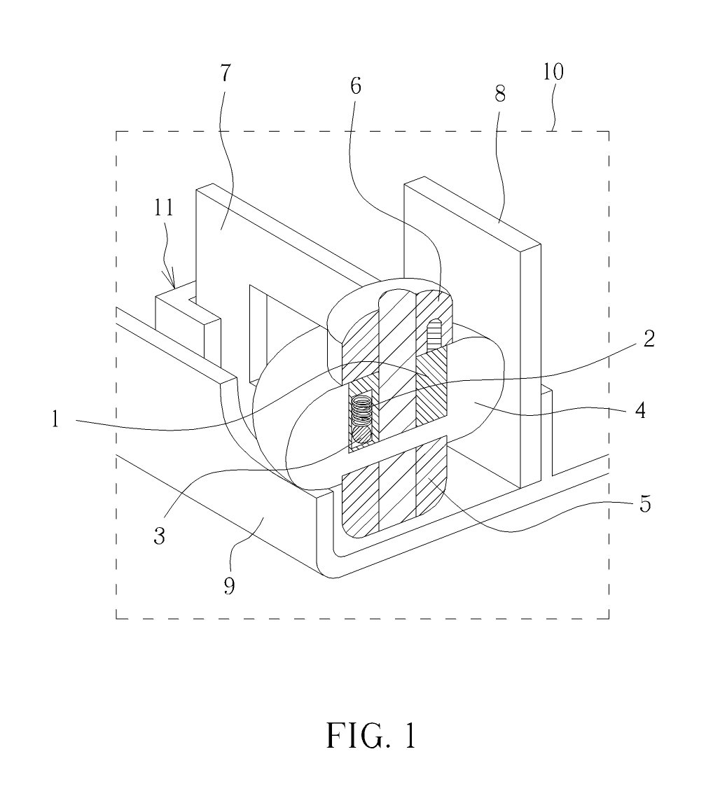

Please refer to FIG. 1, which is a sectional diagram of a mouse 10 according to an embodiment of the present invention. As shown in FIG. 1, the mouse 10 includes a main body 11, an embedded shaft 1, an elastic member 2, a ball 3, a scroll-wheel ring 4, and a circuit board 8. The scroll-wheel ring 4 is rotatably disposed in the main body 11. The embedded shaft 1 is fixed to the main body 11 and embedded into the scroll-wheel ring 4. In this embodiment, the scroll-wheel ring 4 could take a center axis of the scroll-wheel ring 4 as a rotating axis to rotate relative to the main body 11 along an outer cylindrical surface of the embedded shaft 1. The elastic member 2 and the ball 3 are disposed in the embedded shaft 1. The circuit board 8 is located at a side of the scroll-wheel ring 4. More detailed description for the aforesaid components is provided as follows.

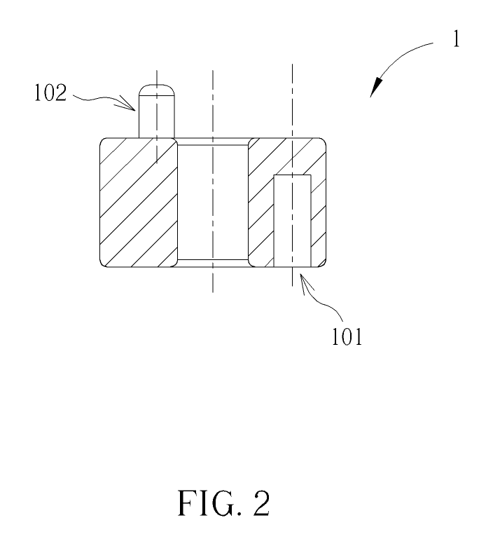

Please refer to FIG. 2, which is a sectional diagram of the embedded shaft 1 in FIG. 1. As shown in FIG. 1 and FIG. 2, in this embodiment, the embedded shaft 1 has a containing space 101 formed therein. The elastic member 2 and the ball 3 are disposed in the containing space 101. In this embodiment, the elastic member 2 could be a spring, but not limited thereto. That is, in other embodiment, the elastic member 2 could be other elastic structure, such as an elastic rod or an elastic sheet.

In this embodiment, the elastic member 2 and the ball 3 could be disposed in the embedded shaft 1 sequentially. At this time, an end of the elastic member 2 abuts against an inner wall of the containing space 101 (i.e. a bottom of the containing space 101), and the other end of the elastic member 2 abuts against the ball 3. Furthermore, for preventing jamming of the elastic member 2 in the containing space 101, a gap could be formed between the elastic member 2 and the containing space 101, so that the containing space 101 could allow the elastic member 2 to expand or contract smoothly when elastic deformation of the elastic member 2 occurs. In this embodiment, a lubricant could be coated between the elastic member 2 and the ball 3 for lubrication, but not limited thereto.

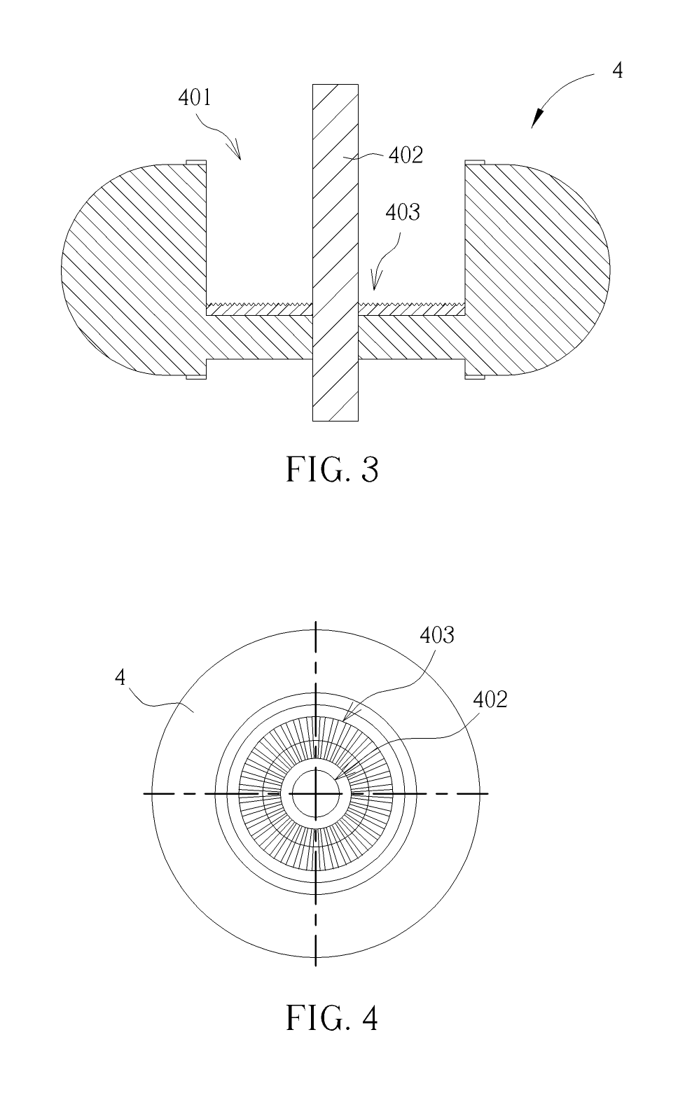

Please refer to FIG. 1, FIG. 3 and FIG. 4. FIG. 3 is a sectional diagram of the scroll-wheel ring 4 in FIG. 1. FIG. 4 is a top view of the scroll-wheel ring 4 in FIG. 3. In this embodiment, the scroll-wheel ring 4 could be a ring-shaped scroll wheel and have a recessed portion 401. The shape and size of the recessed portion 401 could match the shape and size of the embedded shaft 1 (but not limited thereto), so that the scroll-wheel ring 4 could rotate along the outer cylindrical surface of the embedded shaft 1 when the embedded shaft 1 is embedded into the recessed portion 401.

In this embodiment, the scroll-wheel ring 4 could further include a positioning shaft 402. The positioning shaft 402 is located at the center axis of the scroll-wheel ring 4 and disposed through the recessed portion 401. In other embodiment, the positioning shaft 402 could be an omissible component. Furthermore, a small recessed portion could be formed at a bottom of the scroll-wheel ring 4 for facilitating fixing the scroll-wheel ring 4. In this embodiment, the scroll-wheel ring 4 could be made of plastic or plastic steel material, but not limited thereto.

In this embodiment, a ring-shaped gear portion 403 could be formed over the whole bottom surface of the recessed portion 401 of the scroll-wheel ring 4. The ring-shaped gear portion 403 has a plurality of gear teeth 4031 and tooth spaces 4032 alternately formed thereon. The containing space 101 of the embedded shaft 1 opens toward the ring-shaped gear portion 403 of the scroll-wheel ring 4, and the ball 3 contacts the ring-shaped gear portion 403. However, forming of the ring-shaped gear portion 403 is not limited to the aforesaid embodiment. That is, in other embodiment, the ring-shaped gear portion 403 could only be formed on the partial region of the bottom surface of the recessed portion 401 corresponding to the ball 3 as long as the ball 3 could always contact the ring-shaped gear portion 403 during rotation of the scroll-wheel ring 4. In this embodiment, a stretching direction of the elastic member 2 could be parallel to a rotating axis of the scroll-wheel ring 4 (i.e. the center axis of the scroll-wheel ring 4). When the scroll-wheel ring 4 is rotated, the gear teeth 4031 and the elastic member 2 drive the ball 3 to switch between different tooth spaces 4032 with rotation of the scroll-wheel ring 4.

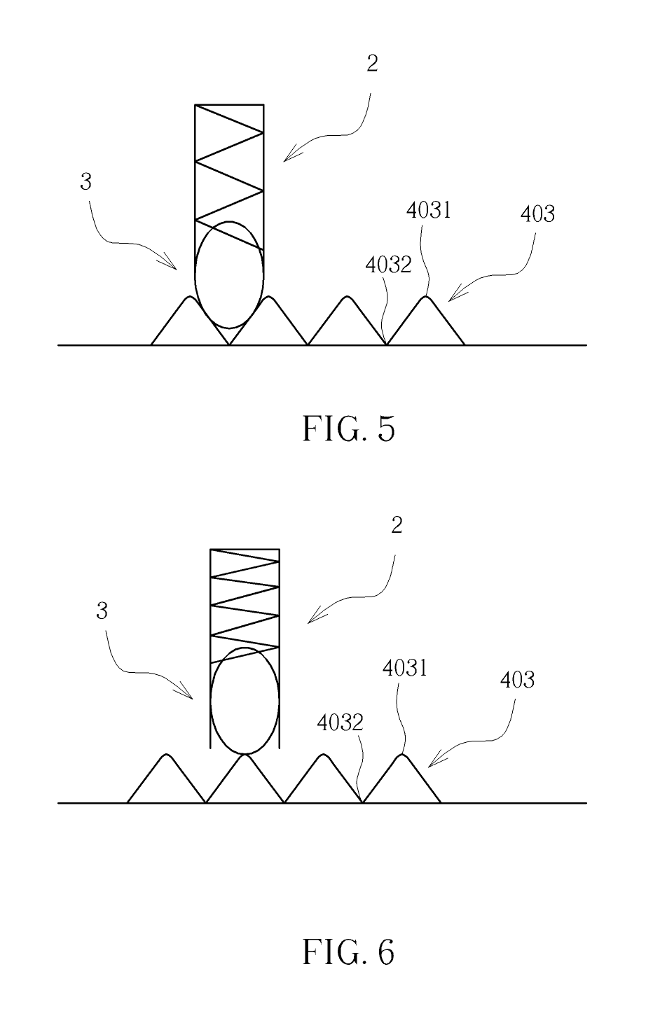

To be more specific, as shown in FIG. 5, when the scroll-wheel ring 4 is not rotated, the ball 3 could be located in one of the tooth spaces 4032, meaning that the ball 3 could be located between two adjacent gear teeth 4031. On the other hand, when the scroll-wheel ring 4 is rotated, as shown in FIG. 6, the next gear tooth 4031 could lift the ball 3 so that the ball 3 could move upward to compress the elastic member 2. Subsequently, when the scroll-wheel ring 4 is rotated to a position where the ball 3 aligns with the next tooth space 4032, the elastic potential energy of the elastic member 2 could be released to make the ball 3 move downward, so as to provide the user with an obvious rolling feeling when the user rotates the scroll-wheel ring 4. To be noted, for preventing the ball 3 from jamming in one tooth space 4032 of the ring-shaped gear portion 403, a distance between two adjacent gear teeth 4031 could be less than the diameter of the ball 3. Furthermore, in this embodiment, the gear teeth 4031 of the ring-shaped gear portion 403 could be arc-shaped for preventing abrasion of the ball 3, but not limited thereto.

In another preferred embodiment, the ring-shaped gear portion 403 could be disposed on an inner circumference wall of the scroll-wheel ring 4. For example, the ring-shaped gear portion 403 could be formed over the whole inner circumference wall of the scroll-wheel ring 4, or only formed on the partial region of the inner circumference wall corresponding to the ball 3. In the aforesaid embodiment, the stretching direction of the elastic member 2 could be perpendicular to the rotating axis of the scroll-wheel ring 4 instead (i.e. a horizontal direction as shown in FIG. 1).

It should be mentioned that the scroll-wheel ring 4 is laterally disposed on a side surface of the main body 11 in FIG. 1 for a clear view of the scroll-wheel ring 4. Since the ball 3 could always abut against the ring-shaped gear portion 403 not only by gravity but also by expansion and contraction of the elastic member 2 caused by the height differences between the gear teeth 4031 and tooth spaces 4032 of the ring-shaped gear portion 403, the scroll-wheel ring 4 could also be vertically disposed between left and right buttons located on an upper surface of the main body 11 like a scroll wheel of a conventional mouse.

Please refer to FIG. 1 again. In this embodiment, the main body 11 could include an outer casing 9 and a fixed board 7. The outer casing 9 could be regarded as a whole casing of the mouse 10. The fixed board 7 is fixed in the casing 9. In the manufacturing process of the mouse 10, the outer casing 9 could be integrally formed with the fixed board 7, but not limited thereto. The fixed board 7 could be made of elastic material, such as plastic or metal material. In such a manner, when the scroll-wheel ring 4 is pressed in a direction perpendicular to the fixed board 7 (e.g. when the scroll-wheel ring 4 in FIG. 1 is pressed rightward), the scroll-wheel ring 4 could be driven to return to its original position by releasing the elastic potential energy of the fixed board 7. In the following, the structural design of the fixed board 7 is described in detail.

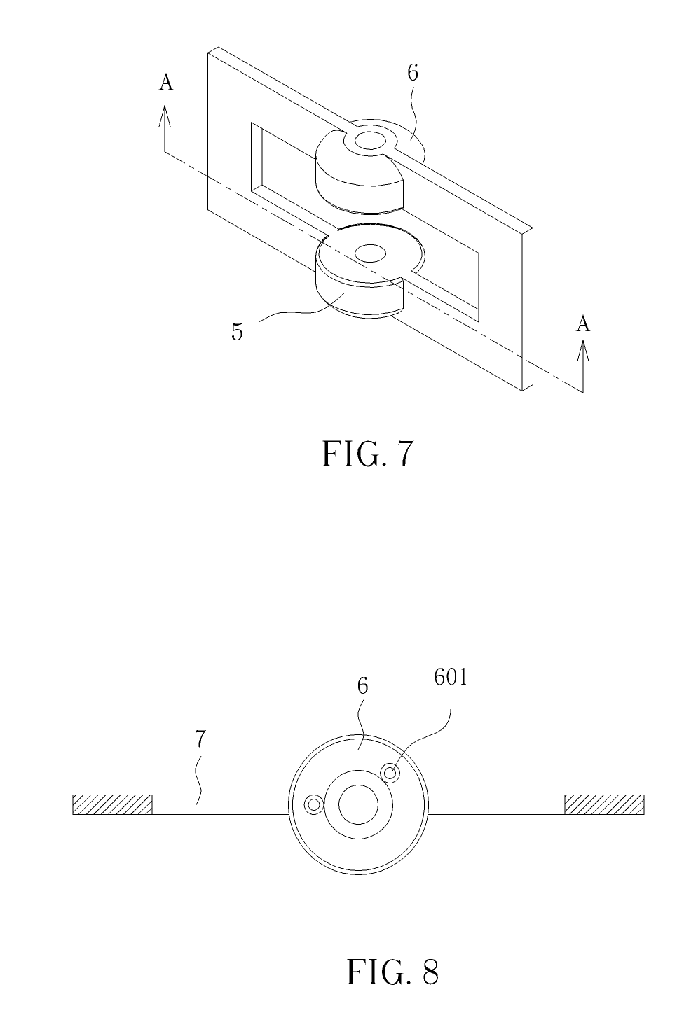

Please refer to FIG. 1, FIG. 7, and FIG. 8. FIG. 7 is an enlarged diagram of the fixed board 7 in FIG. 1. FIG. 8 is a sectional diagram of the fixed board 7 in FIG. 7 along a sectional line A-A′. In this embodiment, the fixed board 7 could have a first clamping portion 5 and a second clamping portion 6. The scroll-wheel ring 4 is rotatably clamped between the first clamping portion 5 and the second clamping portion 6. The positioning shaft 402 of the scroll-wheel ring 4 could be rotatably disposed through holes of the first clamping portion 5 and the second clamping portion 6, meaning that the positioning shaft 402 could be rotated in the holes of the first clamping portion 5 and the second clamping portion 6 with rotation of the scroll-wheel ring 4, but not limited thereto. In other embodiment, if the scroll-wheel ring 4 does not have the positioning shaft 402 formed thereon, the mouse 10 could further include a fixed shaft to pass through the first clamping portion 5 and the second clamping portion 6 and to be disposed through a hole of the scroll-wheel ring 4. Furthermore, the embedded shaft 1 could be smaller than the recessed portion 401 of the scroll-wheel ring 4. For example, the embedded shaft 1 could be semi-cylindrical shaped, and the scroll-wheel ring 4 could rotate along the fixed shaft and the outer cylindrical surface of the embedded shaft 1.

In this embodiment, since both of the fixed board 7 and the embedded shaft 1 are independent components, an end portion of the embedded shaft 1 extending from the scroll-wheel ring 4 could have a fixing pin 102, meaning that the fixing pin 102 protrudes from an upper surface of the embedded shaft 1, for preventing the embedded shaft 1 from rotating together with the scroll-wheel ring 4. The second clamping portion 6 could have a fixing hole 601 corresponding to the fixing pin 102. The fixing pin 102 could be fixed in the fixing hole 601 in a screw locking manner or a structural engagement manner, so as to fix the embedded shaft 1 to the main body 11. In other embodiment, without disposal of the fixing pin 102, the main body 11 could be integrally formed with the embedded shaft 1 instead so as to prevent rotation of the embedded shaft 1 relative to the main body 11, but not limited thereto.

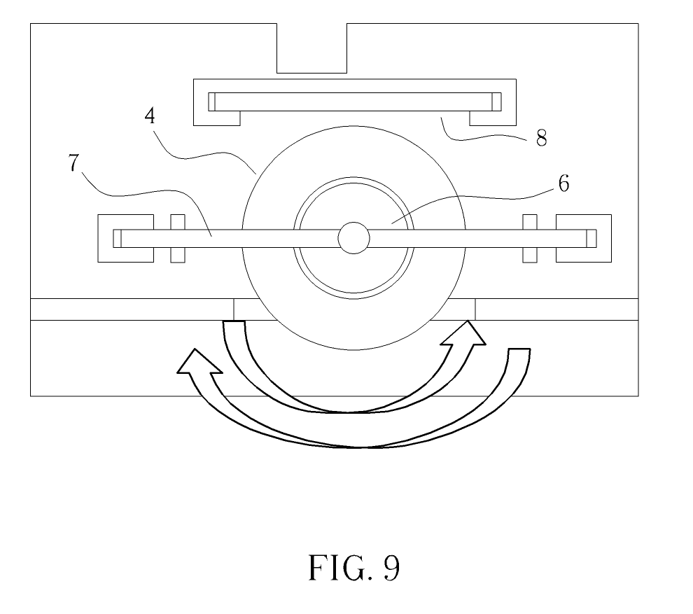

Please refer to FIG. 1 and FIG. 9. FIG. 9 is an assembly diagram of the scroll-wheel ring 4, the fixed board 7, and the circuit board 8 in FIG. 1. In this embodiment, the circuit board 8 could be disposed at a side of the scroll-wheel ring 4 along a direction in which the scroll-wheel ring 4 is pressed (i.e. a right side of the scroll-wheel ring 4 as shown in FIG. 1). Furthermore, the circuit board 8 could be located spaced apart from the scroll-wheel ring 4. In such a manner, when the scroll-wheel ring 4 is pressed, a switch on the circuit board 8 could be triggered accordingly for executing a corresponding button function. When the pressing force exerted on the scroll-wheel ring 4 is released, the scroll-wheel ring 4 could be driven to return to its original position by releasing the elastic potential energy of the elastic member 2.

In summary, in the preferred embodiments of the present invention, when the user rotates the scroll-wheel ring, the gear teeth and the elastic member drive the ball to abut against the ring-shaped gear portion so as to switch between different tooth spaces with rotation of the scroll-wheel ring. In such a manner, the present invention could efficiently solve the prior art problem in which related wheel components in a conventional mouse may collide with each other toughly, so as to achieve the noise reduction purpose. In addition, the present invention could further provide a user with a force feedback to make the user have an improved rolling feeling while rotating the scroll-wheel ring.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mouse comprising:
a main body;
a scroll-wheel ring rotatably disposed in the main body and having a ring-shaped gear portion, the ring-shaped gear portion having a plurality of gear teeth and tooth spaces alternately formed thereon;
an embedded shaft fixed to the main body and embedded into the scroll-wheel ring, the embedded shaft having a containing space opening toward the ring-shaped gear portion;
a ball disposed in the containing space and contacting the ring-shaped gear portion; and
an elastic member disposed in the containing space, one end of the elastic member abutting against an inner wall of the containing space and the other end of the elastic member abutting against the ball;
wherein when the scroll-wheel ring is rotated, the gear teeth and the elastic member drive the ball to switch between different tooth spaces with rotation of the scroll-wheel ring.

2. The mouse of claim 1, wherein the embedded shaft is integrally formed with the main body.

3. The mouse of claim 1, wherein an end portion of the embedded shaft extending from the scroll-wheel ring has a fixing pin, and the fixing pin is used for fixing the embedded shaft to the main body.

4. The mouse of claim 1, wherein the main body comprises an outer casing and a fixed board, the fixed board is fixed in the outer casing and has a first clamping portion and a second clamping portion, and the scroll-wheel ring is rotatably clamped between the first clamping portion and the second clamping portion.

5. The mouse of claim 4, wherein the fixed board is made of elastic material, and when the scroll-wheel ring is pressed in a direction perpendicular to the fixed board, the scroll-wheel ring is driven to return to its original position by releasing the elastic potential energy of the fixed board.

6. The mouse of claim 5 further comprising:
a circuit board disposed at a side of the scroll-wheel ring along the direction in which the scroll-wheel ring is pressed, the circuit board located spaced apart from the scroll-wheel ring.

7. The mouse of claim 1, wherein the scroll-wheel ring further comprises a recessed portion, the ring-shaped gear portion is disposed in the recessed portion, and a stretching direction of the elastic member is parallel to a rotating axis of the scroll-wheel ring.

8. The mouse of claim 7, wherein the scroll-wheel ring further comprises a positioning shaft disposed through the recessed portion and rotatably disposed in the main body.

9. The mouse of claim 1, wherein the ring-shaped gear portion is disposed on an inner circumference wall of the scroll-wheel ring, and a stretching direction of the elastic member is perpendicular to a rotating axis of the scroll-wheel ring.

10. The mouse of claim 1, wherein a lubricant is coated between the elastic member and the ball.

11. The mouse of claim 1, wherein the gear tooth of the ring-shaped gear portion is arc-shaped.

12. The mouse of claim 1, wherein the elastic member comprises a spring or an elastic rod.

13. The mouse of claim 1, wherein the scroll-wheel ring is made of plastic or plastic steel material.
